(19) United States
(12) Patent Application Publication
(10) Pub. No.: US 2007/0175841 A1
(43) Pub. Date: Aug. 2, 2007

(54) Holder and transporter for fluid collecting tubes

(76) Inventors: Christopher Lyon, Euclid, OH (US); David Yarmesch, Brunswick, OH (US)

Correspondence Address: FAY SHARPE LLP, 1100 SUPERIOR AVENUE, SEVENTH FLOOR, CLEVELAND, OH, 44114, US

(21) Appl. No.: 11/520,881

(22) Filed: Sep. 8, 2006

Related U.S. Application Data
(63) Continuation-in-part of application No. 10/753,581, filed on Jan. 8, 2004, now abandoned.
(60) Provisional application No. 60/808,240, filed on May 16, 2006.
(60) Provisional application No. 60/439,203, filed on Jan. 10, 2003.

(51) Int. Cl. A47B 73/00; B01L 9/00

(52) U.S. Cl. 211/74; 422/104

(57) ABSTRACT

A sample collection method and apparatus for holding and transporting tubes is provided which includes a fluid collection tube holder and transporter for use in holding and transporting fluid collection tubes. The tube holder includes an elongated body with a plurality of sleeves thereon for receiving and retaining a plurality of fluid collection tubes. Each of the plurality of fluid collection tubes includes a first end, an enlarged second end, and a cylindrical body therebetween. Each of the plurality of sleeves include an inner surface having a plurality of contact edges extending inwardly for frictionally engaging an exterior side of the cylindrical body of one of the plurality of fluid collection tubes. The sleeves define a circumferential contact area between the inner surface of the sleeve and the exterior side of cylindrical body, the circumferential contact area between the inner surface and the cylindrical body is discontinuous when the tube is mounted in the sleeve. The plurality of edges defines an expandable inner circle circumscribing the plurality of contact edges wherein the inner circle is expandable from a first diameter to a second diameter.

The present application claims priority to provisional patent application Ser. No. 60/808,240, filed May 17, 2006. In addition, the present application is a continuation-in-part of and claims priority to application Ser. No. 10/753,581, filed Jan. 8, 2004, which in turn claims priority to provisional patent application Ser. No. 60/439,203, filed Jan. 10, 2003.

### BACKGROUND

This disclosure relates to a holding, safety, and transporting device, and method, for collecting fluids for laboratory testing and, to a device for securing undiluted and substantially uncontaminated blood samples for laboratory testing.

The use of hypodermic needles in collecting fluids, particularly collecting multiple blood samples in evacuated tubes from a donor or patient presents a cumbersome and dangerous condition with respect to accidental needle sticks (or needle nicks) to anyone exposed to such needles, and/or the accidental mishandling of the blood samples. This is especially true for the technician or drawer collecting the fluid or blood sample. The situation is especially aggravated when the individual is a paramedic (or other health care worker, i.e. nurse, emergency room technician, etc.) and the multiple blood samples are being collected from the donor in a moving vehicle and/or in an emergency situation.

After collecting a sample, the hypodermic needle and blood sample can be contaminated by a variety of disease-causing agents such as, but not limited to, hepatitis B virus or HIV, the virus which leads to acquired immune deficiency syndrome (AIDS). These and other diseases can be transmitted to any person who is stuck, nicked, or poked by a disease-contaminated needle and/or exposed to a mishandled sample. Due to the hectic conditions often present in emergency as well as hospital settings, one or more needles and/or one or more collection tubes can often be found lying about in the presence of patients, ambulance personnel, hospital personnel, et al. A mishandled or destroyed blood sample results in additional time or in an additional needle stick to the donor/patient in order to recollect a blood sample. Furthermore, all health care personnel accidentally stuck or nicked by a previously used needle must go through a series of blood tests in order to ascertain whether they have been infected. Therefore, it is desirable to provide a device for managing the manual handling of the collection tube containers and for maintaining specimen integrity, as well as to minimize the dangers associated with needle stick injuries by minimizing exposure to contaminated needles.

Often, mishandling of the blood samples and/or needle stick injuries occur when a paramedic, nurse, phlebotomist, medical technician, etc. (collectively referred to as “drawer”) attempts to collect multiple samples of blood in separate collection tubes such as, but not limited to, a VACUTAINER® tube. VACUTAINER® is a federally registered trademark of Becton Dickinson Company. VACUTAINER® tubes are commonly used for collecting blood samples. VACUTAINER® tubes are evacuated to facilitate “pulling” in an amount of liquid or blood for subsequent testing. The tubes can be closed with a needle-penetrable stopper that is pierceable with a hypodermic needle to facilitate “pulling” out the proper amount of liquid (or blood) for the particular test. The needle penetrable stopper seals the VACUTAINER® tube upon withdrawal of the hypodermic needle. VACUTAINER® tubes or evacuated collection tubes provide the pressure differential necessary to facilitate flow and collection of the blood. Multiple blood samples are often necessary when a variety of tests are to be run or when confirmation tests are required. The typical protocol for emergency patients en route to a hospital facility for treatment routinely requires five to six separate blood collection tubes to be filled with blood samples. To eliminate patient discomfort from multiple needle sticks, it is desirable to collect a sufficient amount of blood, which can supply all the individual VACUTAINER® tubes, with a single insertion of a hypodermic or phlebotomy needle into the vein of a donor.

VACUTAINER® tubes are used to collect the blood samples and prevent the blood samples from becoming contaminated. Typically, when blood is collected directly from the patient or blood donor, some type of flexible tubing or blood sample retriever having a double-ended needle cannula or two juxtaposed hollow needles attached thereto is utilized. Located at one end of this tubing/retriever is the intravenous (IV) end of the needle, which is inserted into the vein of a patient or donor to draw blood. At a second end is a depositing needle used to penetrate the stopper for establishing fluid communication and depositing blood in the VACUTAINER® tubes. The pressure differential causes blood to flow into the tube. When the blood has reached a preselected level in the tube, the tube is withdrawn from the depositing needle. The depositing needle must be withdrawn and inserted into multiple numbers of stopper sealed tubes in order to collect the requisite number of samples of blood. The blood sampling tubes may contain one of a variety of preparations to facilitate a particular analytical procedure. Such preparations may include, for example, preservatives, anti-coagulants, and the like. This repeated transfer of the depositing needle between the separate fluid collection tubes creates multiple opportunities for needle stick injuries to occur to the drawer. This procedure also creates multiple opportunities for mishandling, i.e. dropping, each individual and unsecured VACUTAINER® tube. Therefore, it is desirable to improve the handling, transporting, and specimen integrity of the individual VACUTAINER® tubes as well as to minimize the danger of spreading diseases from the patient to the drawer by precluding the incidents of needle stick injuries and mishandling of tubes during blood sample collection.

Various patents have issued for devices which protect medical professionals from needle stick injuries or provide a mechanism for holding multiple VACUTAINER® tubes. For example, U.S. Pat. No. 4,982,850 to Mears discloses a test tube holder with a safety shield. Another patent, U.S. Pat. No. 5,951,524 to Enriquez discloses a guard and holder for various sized VACUTAINER® tubes which provides a circular rigid plate capable of protecting the user's hand from needle sticks.

There remains, however, a need for an improved holder, transporter, identifier, and safety device.

### SUMMARY

The present disclosure provides an improvement for holding and transporting tubes of the type described above which overcome the above referred to difficulties and others, and is easy to manipulate, orient, store and use. More particularly in this respect, an apparatus for holding and transporting fluid collection tubes is provided which includes a tube holder having an elongated body with a plurality of open-ended expandable sleeves having a circumferential dimension and a length for receiving and retaining a plurality of fluid collection tubes. The sleeves are spaced from and parallel to one another. The fluid collection tubes include a first end, an enlarged second end, and a cylindrical body therebetween. The circumferential dimension of the sleeves is sized to permit the first end from passing therethrough while preventing the second end from passing therethrough. The fluid collection tubes can be pushed from the second end in a first direction for mounting to the tube holder and then pushed from the first end in a second direction for dismounting from the tube holder. The tube holder can include another expandable sleeve having another circumferential dimension for receiving a sample retriever tube. Each of the sleeves can include an inner surface having at least two contact ribs extending inwardly for releasably gripping the fluid collection tubes and the sample retriever tube.

In accordance with the present disclosure, an apparatus is provided which includes a fluid collection tube holder and transporter for use in holding and transporting fluid collection tubes. The tube holder includes an elongated body with a plurality of sleeves thereon for receiving and retaining a plurality of fluid collection tubes. Each of the plurality of fluid collection tubes includes a first end, an enlarged second end, and a cylindrical body therebetween. Each of the plurality of sleeves include an inner surface having a plurality of contact edges extending inwardly for frictionally engaging an exterior side of the cylindrical body of one of the plurality of fluid collection tubes. The sleeves define a circumferential contact area between the inner surface of the sleeve and the exterior side of cylindrical body, the circumferential contact area between the inner surface and the cylindrical body is discontinuous when the tube is mounted in the sleeve. The plurality of edges defines an expandable inner circle circumscribing the plurality of contact edges wherein the inner circle is expandable from a first diameter to a second diameter.

In one embodiment, the device is flexible and small enough that a drawer can carry the device in a pocket and/or store multiple devices in a small compartment. The device is inexpensive enough to be a throw-away or one use disposable item, but can be designed for reuse.

Further, an apparatus for holding and transporting tubes is provided which includes a tube holder having at least one fluid collection sleeve thereon for receiving and retaining at least one fluid collection tube. The tube holder includes a first member and a second member for retaining a securing band therebetween.

Yet further, an apparatus for holding and transporting tubes is provided which includes a tube holder having at least one fluid collection sleeve thereon. A protective guard can be connected to a side of the holder and includes at least one fluid collection opening therethrough. The at least one fluid collection opening is aligned with the at least one fluid collection sleeve for receiving and retaining at least one fluid collection tube.

Still further, a method of collecting fluid samples from a donor is provided which includes the following steps: mounting a tube holder to a donor's arm, the tube holder includes at least one fluid collection sleeve thereon for receiving and retaining at least one fluid collection tube, the tube holder is moveable about the arm; moving the at least one fluid collection tube toward a depositing needle, the needle is in communication with the fluid sample; filling the at least one fluid collection tube with the fluid sample; and, moving the at least one fluid collection tube away from the depositing needle.

In yet still a further aspect, an apparatus for holding and transporting tubes is provided which includes a tube holder having an elongated body with a plurality of flexible sleeves thereon for receiving and retaining a plurality of fluid collection tubes. The sleeves each include an inner surface having at least one contact rib extending inwardly adapted to frictionally engage the fluid collection tubes.

In another aspect, an apparatus for holding and transporting tubes is provided which includes a tube holder having an elongated body with at least one sleeve thereon for receiving and retaining at least one fluid collection tube. The at least one sleeve includes an inner surface having a plurality of edges defining a discontinuous contact surface for frictionally engaging the at least one fluid collection tube. The plurality of edges defines an inner circle circumscribing the plurality of edges wherein the inner circle has a first diameter.

And still a further aspect, a method of collecting fluid samples from a donor is provided comprising the steps of: mounting a tube holder to a drawer's hand, the tube holder includes a flexible body having at least one sleeve thereon for receiving and retaining at least one fluid collection tube; removing the at least one fluid collection tube from the holder and engaging a depositing needle which is in fluid communication with a fluid sample; filling the at least one fluid collection tube with the fluid sample; and, moving the at least one fluid collection tube away from the depositing needle and replacing the at least one fluid collection tube in the holder.

### BRIEF DESCRIPTION OF THE DRAWINGS

The present disclosure may take physical form in certain parts and arrangement of parts, embodiments of which will be described in detail in the specification, and are illustrated in the accompanying drawings, which form a part hereof and wherein:

FIG. 1 is a perspective view of a tube holder device according to a first embodiment with a retaining or mounting strap/band secured around a drawer's hand;

FIG. 2 is a top plan view of a collecting tube holder according to the first embodiment;

FIG. 3 is a top plan view of the collecting tube holder according to the first embodiment with collecting tubes secured within a series of retaining sleeves;

FIG. 4 is a side view of the holder showing a number of collecting tubes within the retaining sleeves according to the first embodiment;

FIG. 5 is a top plan view of a tube holder device according to a second embodiment including a safety guard;

FIG. 6 is a top plan view of the collecting tube holder according to the second embodiment including collecting tubes secured within the retaining sleeves;

FIG. 7 is a side view of the tuber holder according to the second embodiment;

FIG. 8 is a perspective view of the tube holder device according to the second embodiment with a mounting band secured around a donor's arm;

FIG. 9 is a side view of the tube holder according to the first embodiment showing a mounting band (i.e. rubber band) attached to a pair of retaining hooks;

FIG. 10 is a front view of the tube holder according to the first embodiment showing the collecting tube holder secured to an IV bag and IV pole;

FIG. 11 is a side view of the tube holder according to the first embodiment showing the collecting tube holder secured to an IV bag and IV pole;

FIG. 12 is a perspective view of a collecting tube holder device according to a third embodiment;

FIG. 13 is a side view of the collecting tube holder according to the third embodiment;

FIG. 14 is a side view of the collecting tube holder according to the fourth embodiment;

FIG. 15 is a perspective view of the collecting tube holder according to the fourth embodiment with several fluid collecting tubes contained therein;

FIG. 16 is a side view of the collecting tube holder according to the fourth embodiment with several fluid collecting tubes contained therein;

FIG. 17 is a perspective view of the collecting tube holder according to the fourth embodiment with several fluid collecting tubes contained therein; and,

FIG. 18 is a bottom perspective view of the collecting tube holder according to the fourth embodiment with each one of the sleeves containing a fluid collecting tube, sample retriever tube, or needle system therein.

### DETAILED DESCRIPTION

Referring now in greater detail to the drawings, wherein the showings are for the purpose of illustrating embodiments of the disclosure only, and not for the purpose of limiting same, FIGS. 1-4 illustrate a flexible tube holder 10 incorporating an embodiment of the disclosure. The tube holder 10 can be formed of a durable resilient material such as, but not limited to, a plastic or polymer material. The plastic or polymer material typically includes a material such as, but not limited to, polyvinyl chloride plastic or any other suitable plastic by extrusion, molding, or any suitable plastic forming technique.

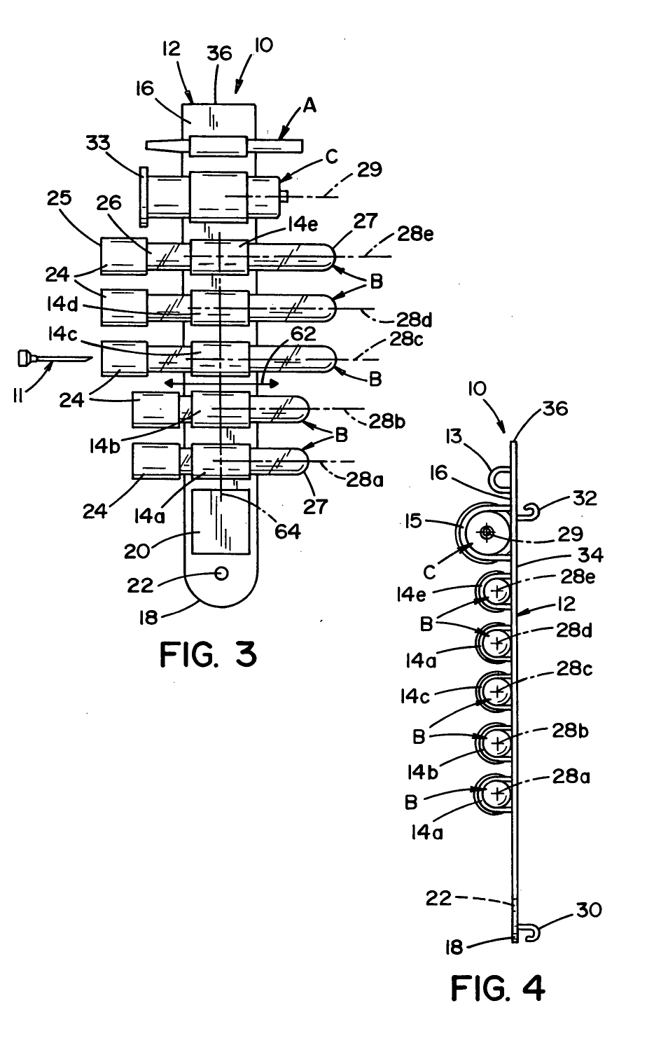

Referring to FIG. 1, a perspective view of the tube holder device 10 of the present disclosure is shown as mounted to a drawer's hand H. Typically, a standard blood drawing situation requires that a series of blood samples be collected from a donor and deposited into separate collection tubes. The sample collection typically is drawn from a location proximal to the donor's inside lower arm, i.e. opposite the elbow. The standard blood drawing tubing or blood drawing system usually consists of two juxtaposed needle elements (i.e. double-ended needle cannula), a first needle or first end (not shown) is used to penetrate a donor's vein (venipuncture) which allows blood to draw from the vein, and a second needle or second end 11 is used to connect to a sample retriever tube C and transfer (or deposit) the drawn blood into a (or a series of) fluid collection tube(s) B. The tube holder 10 device can comprise an elongated flexible body 12 containing a plurality or row of sleeves 13, 14a, 14b, 14c, 14d, 14e, 15 mounted on a top or front side 16 for holding and retaining a needle system tube A, the collection tubes B, and the sample retriever tube C. The sleeves 13, 14a, 14b, 14c, 14d, 14e, 15 can be formed of a durable resilient material such as, but not limited to, a plastic, elastic, elastomeric, or elastic-plastic material. It will be appreciated that all of the tubes B may be held in the device 10 allowing the drawer or technician use of both hands for manipulating the collection tubes B and needle elements. As illustrated in FIG. 3, the sample retriever tube C has a larger diameter and shorter length than the collection tubes B. The needle system tube A can have a smaller diameter relative to the collection tubes B. In the embodiment of FIGS. 1-4, the sleeves 13, 14a, 14b, 14c, 14d, 14e, 15 are generally parallel and can be adapted and sized to hold the typical sizes of needle system tube A, blood collection tubes B, and also one (or more) blood sample retriever tube(s) C. The sleeves 14a, 14b, 14c, 14d, 14e can have a different diameter than sleeves 15 and 13 and can be adapted by, for example, including a ridge(s) or taper along the interior surface of the sleeve (not illustrated). Additionally, the sleeves 13, 14a, 14b, 14c, 14d, 14e, 15 can include a distorted, pinched, restricted, partially collapsed, etc. opening at one or both ends (not illustrated) to facilitate retention of a variety of tube diameters.

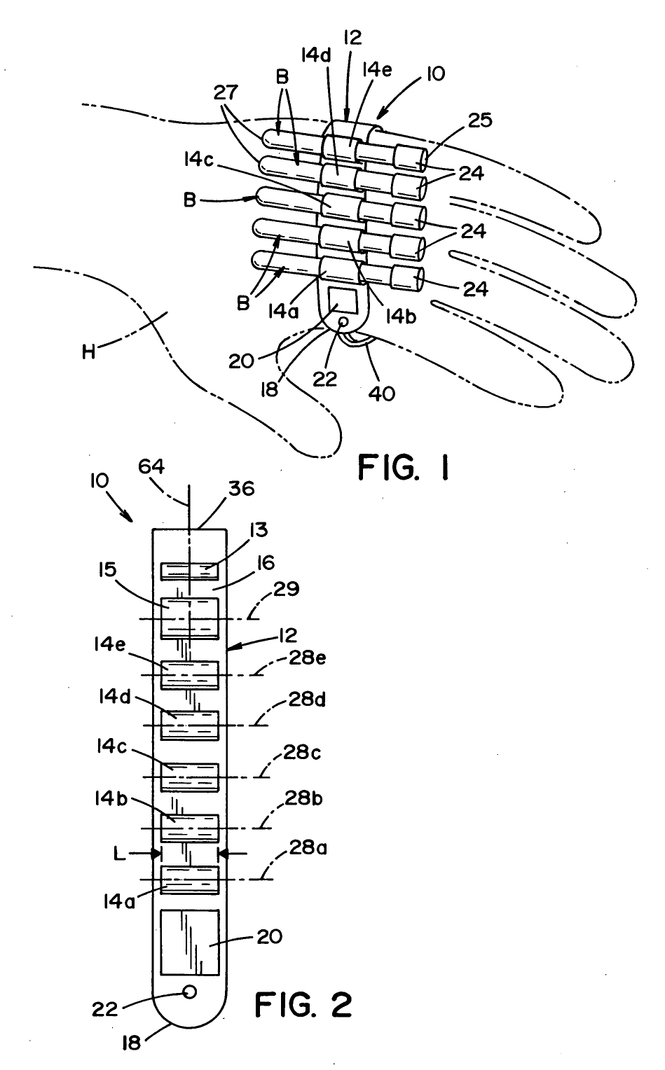

Referring to FIG. 2, a top plan view of the tube holder 10 device is shown without the tubes A, B, and C retained in the retaining sleeves 13, 14a, 14b, 14c, 14d, 14e, 15. At one end 18 of the tube holder 10 device, a donor/patient identification area or label 20 can be provided for writing a donor's name, date, time, drawer's name, forms/methods used for patient identification, etc. Also included is a hole 22 for hanging on an IV pole 23 or related apparatus as will be described hereinafter. FIG. 3 is a top plan view of the tube holder 10 device showing a plurality of collection tubes B retained in the retaining sleeves 14a, 14b, 14c, 14d, 14e. Additionally, the sample retriever tube C and needle system tube A can also be retained in retaining sleeves 15 and 13. Typically, the tubes B that are used for collection are the type known in the medical profession as VACUTAINER® tubes. The VACUTAINER® tubes are designed in such a way that a top end 25 is open and a bottom end 27 is closed. The top end 25 includes a rubber stopper 24 around a neck 26 of the tube B. It is to be appreciated that the sleeves 14a, 14b, 14c, 14d, 14e can be sized to allow the tubes B to pass therethrough along a corresponding axis 28a, 28b, 28c, 28d, 28e, but restrict the rubber stoppers 24 proximal to the neck 26 from passing therethrough. Similarly, sleeve 15 can be sized to allow tube C to pass therethrough along a corresponding axis 29, but restrict a flange 33 from passing therethrough. The rubber stopper 24 includes a piercable inner lining, not illustrated, which may be pierced by the depositing needle 11. In light of the fact that varying amounts of blood are required for different types of laboratory analysis, the retaining sleeves 14a, 14b, 14c, 14d, 14e have been designed such that different sized (i.e. different diameters, volumes, lengths, etc.) fluid collection tubes B may be retained by the present invention. The fluid collection tubes B having diameters of between 1.2 and 1.6 cm are generally the most common sizes used for collecting blood samples. However, the tubes can have other sizes which are used, for example, in pediatrics, blood cultures, blood gas collection, etc.

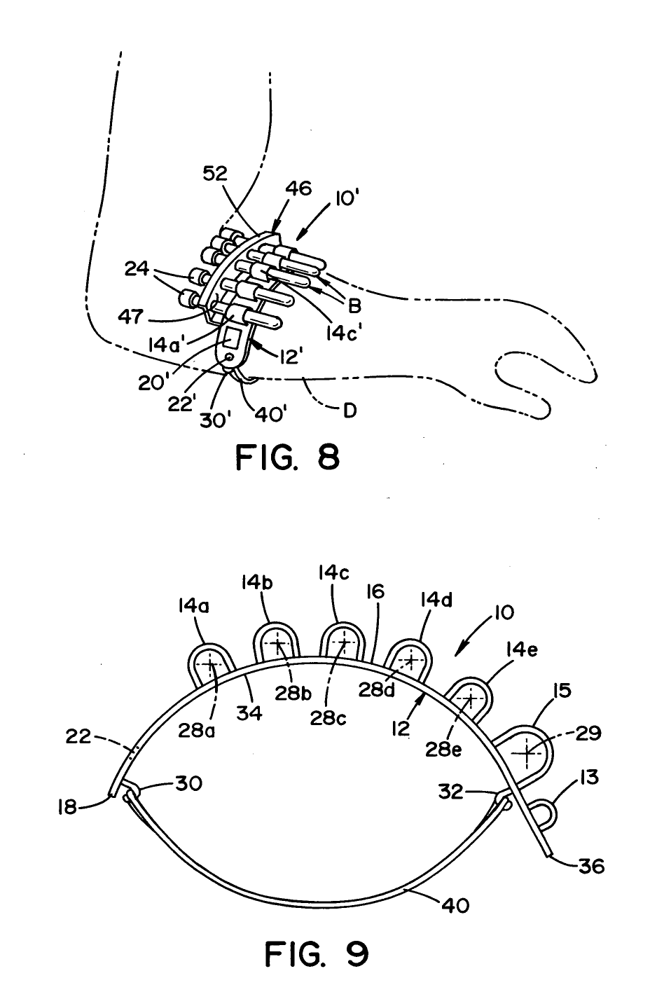

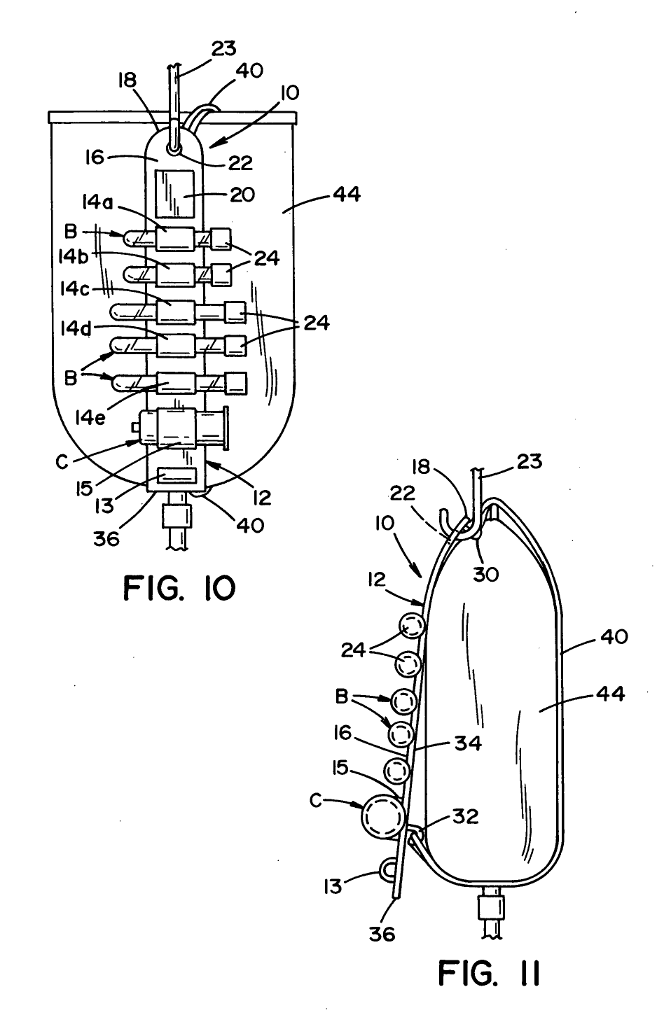

FIG. 4 represents a side view of the tube holder 10 showing the tubes B, C secured in the retaining sleeves 14a, 14b, 14c, 14d, 14e, 15 and also showing a pair of hooks 30, 32 connected to a bottom or back side 34 of the body 12. A first hook 30 can be located at the top end 18 and a second hook 32 can be located proximate to an opposing end 36 of the body 12. The hooks 30, 32 can be used to secure a mounting or securing band 40 (FIG. 9) such that the tube holder 10 and the mounting band 40 can form a flexible and elastic circumferential band which is adapted to surround a technician's hand H (FIG. 1), a donor's arm D (FIG. 8), or an IV bag 44 (FIGS. 10 and 11) which will be described hereinafter. It is to be appreciated that the securing band 40 can be retained by any number of devices. For example, a second hole (not illustrated) can be proximal to end 18 for passing and looping band 40 therethrough. The opposing end of the band can be looped around sleeve 15 (not illustrated) to form a flexible and elastic circumferential band.

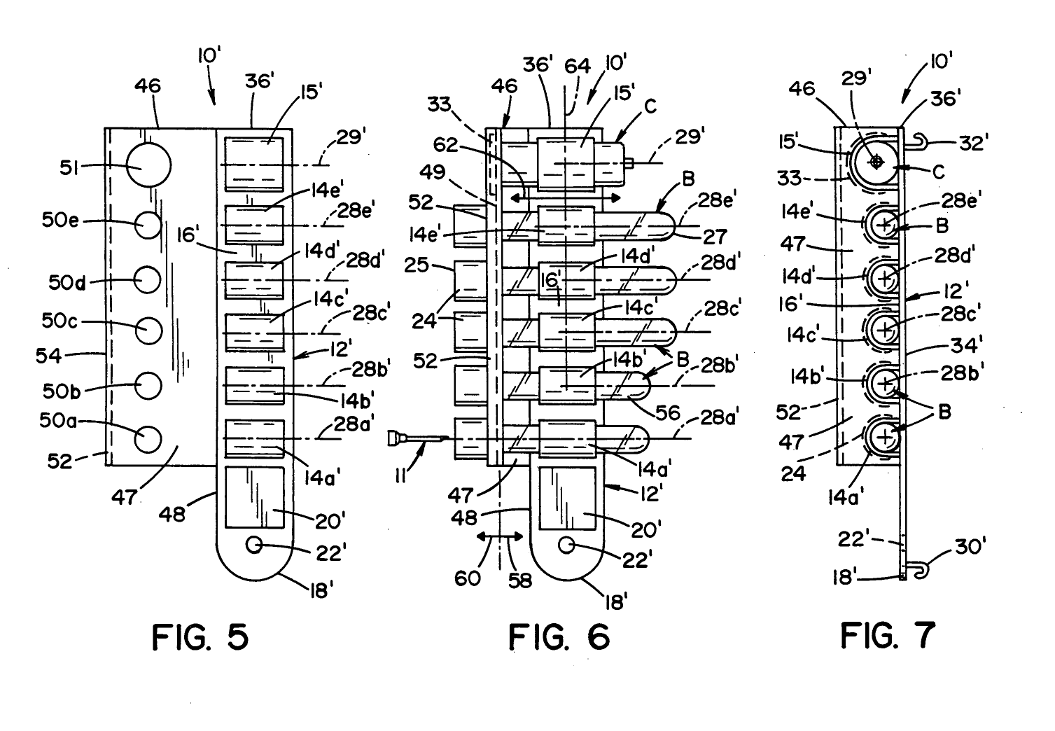

A tube holder incorporating another embodiment of the disclosure is shown in FIGS. 5-8. Like components are identified with like numerals including a primed (′) suffix and new components are illustrated by new numerals. A tube holder 10′ is shown with a protective guard 46. The flexible protective guard 46 or safety shield is shown extending from a side 48 of the tube band body 12′. The protective guard 46 includes a series of openings 50a, 50b, 50c, 50d, 50e configured to receive tubes B and an opening 51 configured to receive the sample retriever tube C. The guard 46 can include an outwardly projecting rim 52 extending along an edge 54 of the protective guard 46. The guard 46 can include soft, flexible top and bottom surfaces 47, 49, respectively. The flexible bottom surface 49 and the projecting rim 52 can be used for the purpose of stopping travel of the needle 11 and preventing the needle 11 from slipping off the guard 46 and striking the drawer's fingers. The flexible guard 46, as shown in FIG. 5, can be flat and coplanar with the band body 12′ or can be folded behind the body 12′, not illustrated, in an inactive position. As shown in FIGS. 6, 7 and 8, the flexible protective guard 46 is folded upward generally perpendicular or orthogonal to the body 12′ whereby a series of tubes B can be inserted first through the openings 50a, 50b, 50c, 50d, 50e and second through the associated retaining sleeves 14a′, 14b′, 14c′, 14d′, 14e′ along respective axes 28a′, 28b′, 28c′, 28d′, 28e′. In this configuration, a bottom section 56 of the tubes B to one side 58 of the protective guard 46 are separated from their respective rubber stoppers 24 at an opposing side 60 of the guard 46. It is to be appreciated that the openings 50a, 50b, 50c, 50d, 50e can be sized to allow the tubes B to pass therethrough but restrict the rubber stoppers 24 from passing therethrough. The protective guard 46 can shield and protect the drawer's fingers from a needle stick injury while taking fluid samples directly from the patient or donor. Similarly, tube C can be inserted first through the opening 51 and second through the associated retaining sleeve 15′ along a respective axis 29′.

It is to be appreciated that the drawer's fingers can be used to slide an individual tube B toward the depositing needle 11 while the fingers remain on side 58 and protected from the needle 11, and while the tubes B remain retained in sleeves 14a′, 14b′, 14c′, 14d′, 14e′. Referring to FIG. 6, it is to be appreciated that each tube B in the tube holder arrangement can in turn be urged toward and away from the depositing needle 11 while, for example, the tube holder 10′ is wrapped around a donor's arm with a band 40′. As described above, the depositing needle 11 pierces the piercable inner liner at the top end 25 of the tube B. As such, the needle 11 remains on one side 60 of the protective guard 46 and the drawer's fingers remain on the other side 58 of the protective guard 46. The retaining sleeves 14a′, 14b′, 14c′, 14d′, 14e′ are of sufficient length L such as to frictionally secure the tubes B while allowing the frictional force to be readily overcome by the drawer to move the tubes B toward and away from the depositing needle 11 while the fingers remain protected from the needle 11 behind guard 46. Similarly, each tube B in the tube holder arrangement can successively, or as needed, be urged toward and away from the depositing needle 11 as each sample is drawn.

Referring to the first embodiment and FIGS. 2-4 and 9, it is to be appreciated that a similar method can be followed, as described above, in which the drawer's fingers can be used to slide an individual tube B toward the depositing needle 11 while the fingers remain distal to the depositing needle 11 and while the tubes B remain retained in sleeves 114a, 114b, 114c, 114d, 114e. Referring to FIG. 3, it is to be appreciated that each tube B in the tube holder arrangement can in turn be urged toward and away from the depositing needle 11 while, for example, the tube holder 10 is wrapped around a donor's arm with the band 40 (not illustrated). As described above, the depositing needle 11 pierces the piercable inner liner at the top end 25 of the tube B. As such, the needle 11 remains distal to the drawer's fingers while the tubes B are urged toward and away from the needle 11. The retaining sleeves 14a, 14b, 14c, 14d, 14e are of sufficient length L such as to frictionally secure the tubes B while allowing the frictional force to be readily overcome by the drawer to move the tubes B toward and away from the depositing needle 11 while the fingers remain distal to the needle 11. Similarly, each tube B in the tube holder arrangement, after rotating or repositioning the tube holder 10, can successively, or as needed, be urged toward and away from the depositing needle 11 as each sample is drawn.

Additionally, the retaining sleeves 14a, 14b, 14c, 14d, 14e on the top side 16 of the body 12 are of sufficient length L such as to reduce rotational mobility of the tubes B tangential to a central axis 64 of the band body 12. Depending on the dimensions of tubes B, length L can be in the range of 12-88% the length of the tubes B between the neck 26 and the bottom end 27. Restricting rotational mobility minimizes the contact of the fluid collection tubes B with each other during use and transport. As a result of preventing the collection tubes B from contacting each other in this manner, the risk of breaking one or more of them during the blood collection process, and/or during transport, can be greatly reduced.

In the second embodiment, the protective guard 46 adds additional points of contact between the perimeters of openings 50a, 50b, 50c, 50d, 50e and tubes B thereby further restricting rotational movement of the individual collection tubes B. As such, while lateral movement 62 transverse to the central axis 64 of the body 12′ toward and away from the depositing needle 11 is somewhat restricted, the retention forces can be overcome. Rotational movement of the tubes B, tangential to the central axis 64, is restricted by the combined retention forces of the sleeves 14a′, 14b′, 14c′, 14d′, 14e′ and the perimeters of openings 50a, 50b, 50c, 50d, 50e in the guard 46.

Referring to FIG. 9, the mounting band 40 for securing the tube holder 10 to a drawer's hand H, donor's arm D, or IV bag 44 is shown. More particularly, FIG. 9 is a side view of the tube holder 10 with the accompanying mounting band 40 (e.g. nylon strap, rubber band, elastic band or other retention band). Fastening members such as hooks or clips 30, 32 are shown on the bottom side 34 of the body 12 at opposing ends of the tube holder 10. As can be appreciated, other fastening arrangements can be used (e.g. Velcro strap, elastic band sewn to tube holder, hole(s) for looping rubber band, etc.) The resilient plastic material of the band body 12 along with the mounting band 40 allows the tube holder 10 to be secured to an IV bag 44 as shown in FIGS. 10 and 11. The hole 22 in the top end 18 of the holder body 12 can also be used for hanging from the associated IV pole 23. In this orientation, the tube holder 10 can secure the collection tubes B, while at the same time, allows for ready access of the tubes B by the medical personnel. Additionally, the patient information, via the label 20, can be displayed and/or accessed for identification and verification purposes. The identification area 20 can be placed on the back side 34 (not shown) to allow for additional space to document information. It will be appreciated that the hole 22 at the top end 18 of the band body 12 of the IV pole 23 therethrough, can maintain the tube holder 10 in an upright position as the IV bag 44 is depleted. When it becomes necessary to change IV bags 44, it is an easy maneuver to remove the tube holder 10 from the IV pole 23 and used bag 44 by unhooking the body 12 and removing the mounting band 40. The used IV bag 44 can then be removed, and upon resecuring a new IV bag to the IV pole 23, the tube holder 10 can be reengaged as described above.

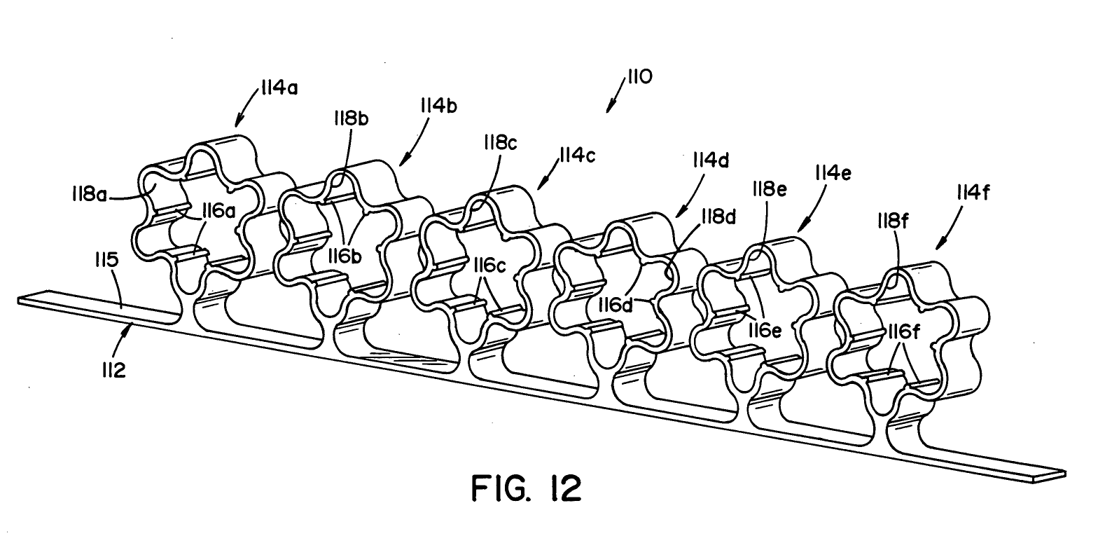

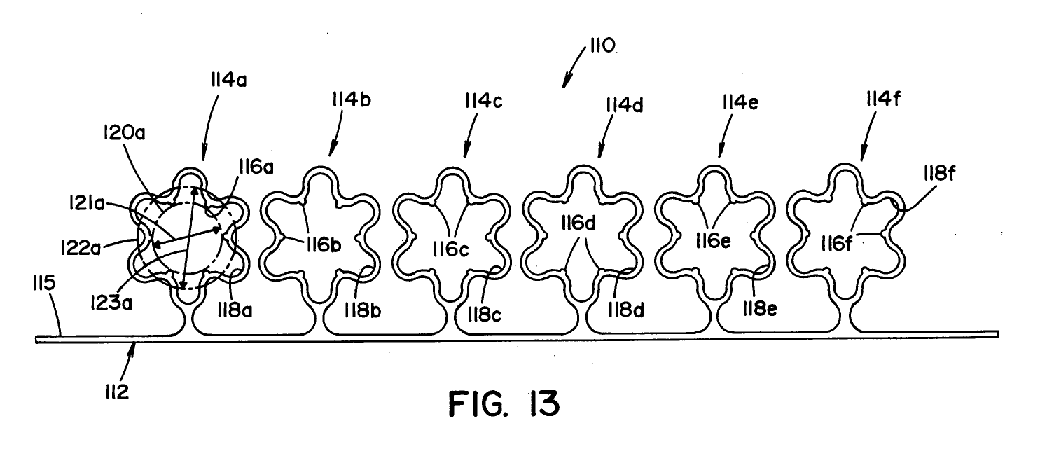

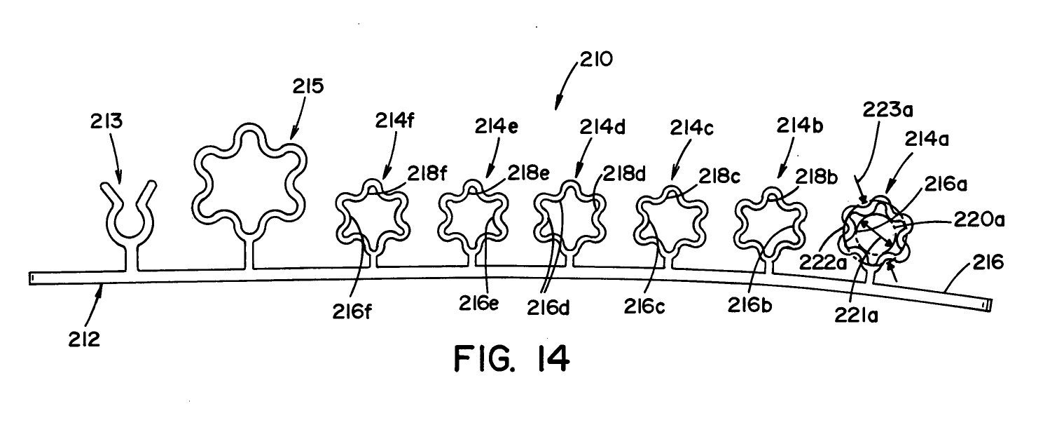

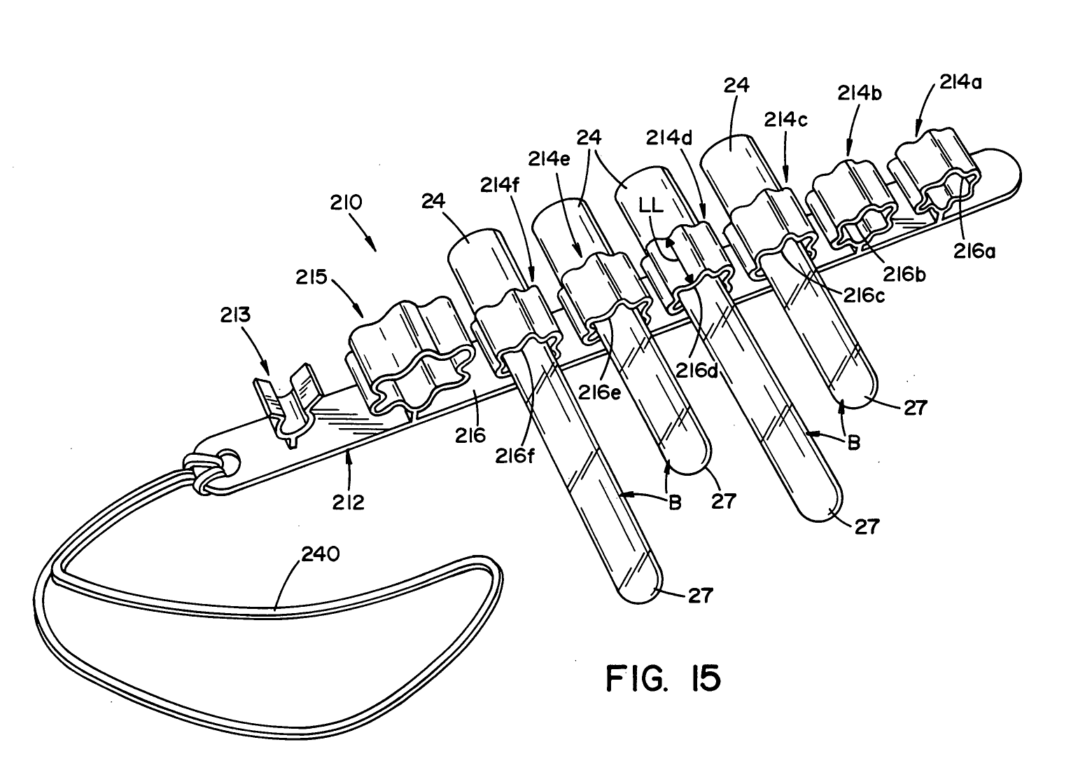

A tube holder incorporating another embodiment is shown in FIGS. 12-13. Referring now in greater detail to the drawings, wherein the showings are for the purpose of illustrating a third embodiment of a tube holder, and not for the purpose of limiting same. FIGS. 12-13 illustrate a flexible tube holder 110 incorporating a third embodiment. As described above, the tube holder 110 can be formed of a durable resilient material such as, but not limited to, a plastic or polymer material.

Referring to FIG. 12, a perspective view of the tube holder device 110 is therein shown. The tube holder 110 device can comprise an elongated flexible body 112 containing a plurality or row of sleeves 114a, 114b, 114c, 114d, 114e, 114f mounted on a top or front side 115 for holding and retaining the fluid collection tubes B. The sleeves 114a, 114b, 114c, 114d, 114e, 114f can be formed of a durable resilient and/or flexible material such as, but not limited to, a plastic, elastic, elastomeric, or elastic-plastic material. It will be appreciated that all of the fluid collection tubes B needed for one patient ‘draw’ may be held in the device 110 allowing the drawer or technician use of both hands for manipulating the collection tubes B, sample retriever tube, and needle elements. In the embodiment of FIGS. 12-13, the sleeves 114a, 114b, 114c, 114d, 114e, 114f are generally parallel to and spaced from one another, and can be adapted and sized to hold the typical (or atypical) sizes of blood collection tubes B (i.e. evacuated tubes). It is to be appreciated that the tube holder can include one or more sleeves (not shown) for holding one (or more) blood sample retriever tube(s) C.

The sleeves 114a, 114b, 114c, 114d, 114e, 114f can be open-ended and configured in a geometric pattern including, for example, a ‘star’ pattern or shape (i.e. 6-pointed star) having multiple inwardly projecting contact ribs or edges 116a, 116b, 116c, 116d, 116e, 116f, respectively, along each inner surface 118a, 118b, 118c, 118d, 118e, 118f of the sleeves. In one exemplary arrangement, the inner surfaces include six (6) inwardly projecting ribs. Any one of the ribs can have another rib located in an opposing (i.e. 180 degrees) position around the inner surface. Additionally, each of the sleeves 114a, 114b, 114c, 114d, 114e, 114f, to their flexibility, geometry, and expandability, can comprise a range in diameter represented, for example in sleeve 114a, by a circle 120a circumscribing the internal ribs of contact 116a and having a circumferential dimension or unexpanded diameter 121a. The sleeves, when expanded, can comprise a circle 122a circumscribing the ribs and having another circumferential dimension or expanded diameter 123a. The expansion and contraction of the resilient sleeves facilitates retention of a variety of typical and atypical collection tube diameters. In one exemplary embodiment, the unexpanded and expanded diameters can range between about 1.1 cm and 1.7 cm thereby facilitating retention of the typical sizes of evacuated tubes.

FIG. 13 represents a side view of the tube holder 110 showing the retaining sleeves 114a, 114b, 114c, 114d, 114e, 114f. Although not illustrated, it is to be appreciated that the sleeves 114a, 114b, 114c, 114d, 114e, 114f can be sized to allow the tubes B, at a first end, to pass therethrough along corresponding axes parallel to the sleeves, but restrict the rubber stoppers 24, or enlarged second end, proximal to the neck 26 from passing therethrough. Further, it is to be appreciated that hooks can be located along the body. The hooks can be used to secure a mounting or securing band such that the tube holder 110 and the mounting band can form a flexible and elastic circumferential band which is adapted to surround a technician's hand, a donor's arm, or an IV bag. It is to be appreciated that the securing band can be retained by any number of devices. For example, a second hole (not illustrated) can be proximal to an end for passing and looping a band therethrough. The opposing end of the band can be looped around one of the sleeves to form a flexible and elastic circumferential band.

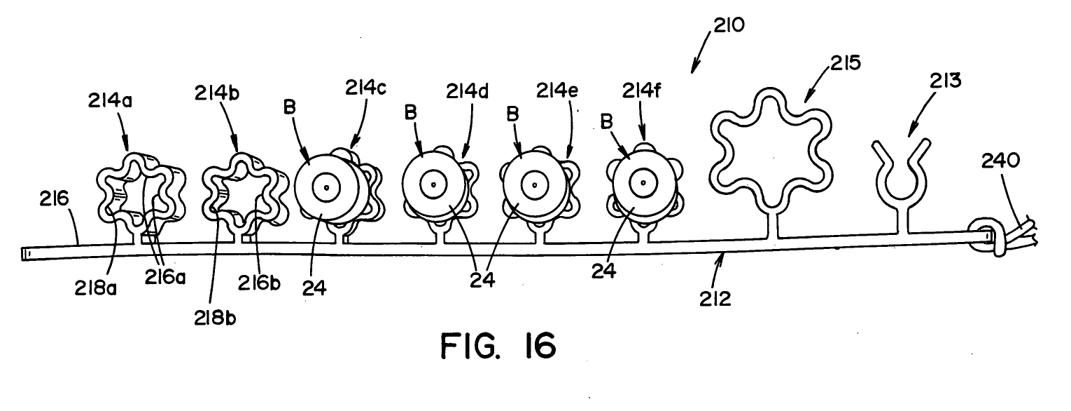

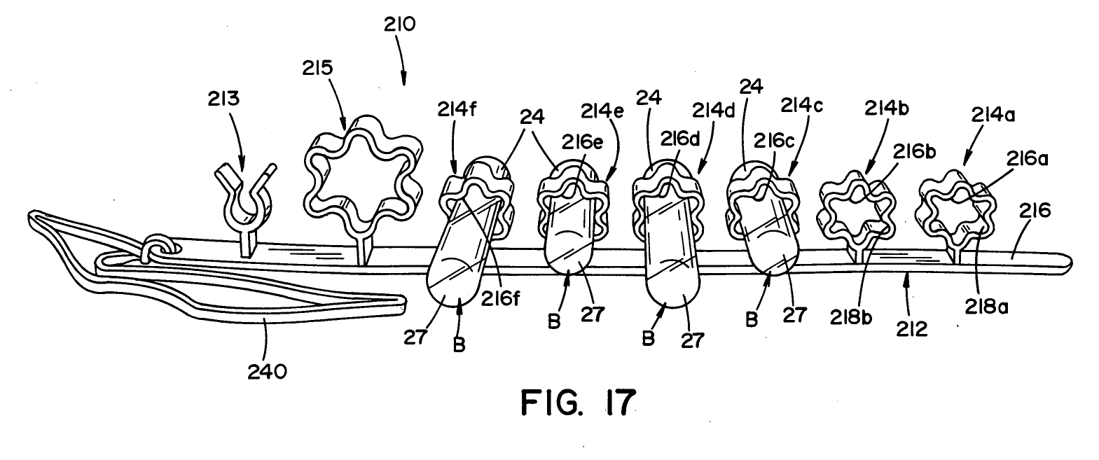

A tube holder incorporating another embodiment is shown in FIGS. 14-18. Referring now in greater detail to the drawings, wherein the showings are for the purpose of illustrating a fourth embodiment, and not for the purpose of limiting same. FIGS. 14-18 illustrate a flexible tube holder 210 incorporating a fourth embodiment. As described above, the tube holder 210 can be formed of a durable resilient, expandable, and/or flexible material such as, but not limited to, a plastic or polymer material.

Referring to FIGS. 14-18, various views of the tube holder device 210 is therein shown. The tube holder 210 device can comprise an elongated flexible body 212 containing a plurality or row of sleeves 214a, 214b, 214c, 214d, 214e, 214f mounted on a top or front side 216 for holding and retaining the collection tubes B. The sleeves 214a, 214b, 214c, 214d, 214e, 214f can be formed of a durable resilient and flexible material such as, but not limited to, a plastic, elastic, elastomeric, or elastic-plastic material. It will be appreciated that all of the tubes B may be held in the device 210 allowing the drawer or technician use of both hands for manipulating the collection tubes B and needle elements. In the embodiment of FIGS. 14-18, the sleeves 214a, 214b, 214c, 214d, 214e, 214f are generally parallel and can be adapted and sized to hold the typical (or atypical) sizes of blood collection tubes B. The tube holder can include one or more sleeves 215 for holding one (or more) blood sample retriever tube(s) C and one or more retaining clips 213 for retaining a needle system tube A. The retaining clip 213 can be an open sided clip wherein the needle system is pushed and pulled orthogonally to the axis of the clip in order to seat the needle system therein and remove therefrom, respectively. It is to be appreciated that the needle system includes a cap or protective covering over the needle. The retention clip 213 provides for the needle system to be retained and removed without inadvertently removing the protective cap.

The sleeves 214a, 214b, 214c, 214d, 214e, 214f can be configured in a geometric pattern including, for example, a ‘star’ pattern or shape (i.e. 6-pointed star) having multiple interior contact edges or ridges 216a, 216b, 216c, 216d, 216e, 216f, respectively, along each inner surface 218a, 218b, 218c, 218d, 218e, 218f of the sleeves. The sleeves can also include multiple outwardly projecting or exterior edges along each outer surface of the sleeves. In one exemplary arrangement, the inner surfaces include six (6) inwardly projecting edges. Any one of the edges can have another edge located in an opposing (i.e. 180 degrees) position around the inner surface. Additionally, the sleeves 214a, 214b, 214c, 214d, 214e, 214f, due to their flexibility, geometry, and expandability, can comprise a range in diameter represented, for example, by a circle 220a circumscribing the inner edges of contact and having a circumferential dimension, first, or unexpanded diameter 221a. The sleeves, when expanded, can comprise a circle 222a circumscribing the edges and having another circumferential dimension, second, or expanded diameter 223a. The sleeves include an outer surface having a plurality of edges defining an outer circle circumscribing the outer edges and including a third diameter. The third diameter is greater than the second diameter.

Although not illustrated, it is to be appreciated that the other sleeves can have similar characteristics. The expansion and contraction of the resilient sleeves facilitates retention of a variety of typical and atypical collection tube diameters. In one exemplary embodiment, the unexpanded and expanded diameters can range between about 1.1 cm and about 1.7 cm.

FIG. 18 displays a bottom view of the device 210 including a textured or porous surface for writing patient or donor information and other pertinent notes (i.e. the donor's name, date, time, drawer's name, etc.).

FIG. 15 presents a perspective view of the tube holder 210 showing the retaining sleeves 214a, 214b, 214c, 214d, 214e, 214f. It is to be appreciated that the sleeves 214a, 214b, 214c, 214d, 214e, 214f can be sized to allow the tubes B to pass therethrough along corresponding axes parallel to the sleeves, but restrict the rubber stoppers 24 proximal to the neck 26 from passing therethrough. It is to be appreciated that a retaining band 240 can be looped through hole at one end and attached to any one of the sleeves at another end (not illustrated) to form a flexible and elastic circumferential band.

Referring again to FIG. 15, it is to be appreciated that the contact length of the inwardly extending edges of the sleeves LL provides a coefficient of friction to the tubes secured therein. As best shown in FIGS. 15-18, the contact length of the sleeves relative to the length of the tubes measured from the bottom of the neck 26 to the terminal end 27 of the tube B, in one version, can be less than 50%. In another version, the contact length of the sleeves relative to the length of the tubes can be less than 33%. And still in another version, the contact length of the sleeves relative to the length of the tubes can be in the range of 15% to 30%. This range leaves the majority of the tube unencumbered for writing on, reading from, or viewing contents therein.

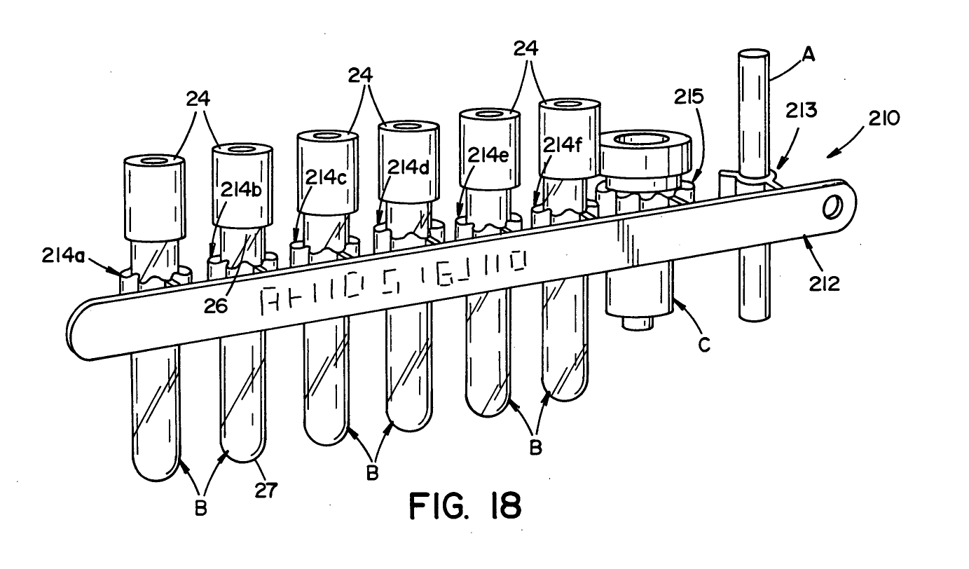

As shown in FIG. 17, a circumferential contact area between the inwardly extending edges, i.e. 216c, and the outer circumference of the tubes B can be in the range of 45% to 85%. The circumferential contact can be discontinuous or interrupted around the outer circumference. The combination of the contact length and contact circumference provides a coefficient of friction or retention force to the tubes which prevents the tubes from slipping out of the sleeves inadvertently regardless of orientation, rotation, or motion. The coefficient of friction provides sufficient retention forces such that even a short or momentary application of force to the terminal end of the tubes will not dislodge the tubes from the sleeves. A sustained and directed force along the respective sleeve axis, i.e. from a drawer, allows the tubes to slide through the sleeves. The coefficient of friction is such that the drawer, using one hand only, can easily overcome the friction forces and slide a tube in and out of its respective sleeve in first and second directions using the outwardly extending edges as a flange for gripping. The first and second directions are co-linear and opposite to one another. In one example, the drawer can place his/her fingers on one side of the sleeve while the thumb is used to push a tube into the sleeve. Subsequently, the drawer can place his/her thumb on one side of the sleeve while the fingers are used to push the tube out of the sleeve. Additionally, the tubes can be rotated by the drawer, with one hand only, while mounted in the respective sleeves for viewing or writing of patient information on the tube itself, and/or to view the contents therein.

The present disclosure enables a drawer to physically manipulate the fluid collection tubes while the tubes are in their respective sleeves. Because the drawer can hold part of the restrained collection tube, the tube is held steady while the drawer attempts insertion and withdrawal of the needle. The process of drawing blood can therefore be done quicker and safer. By providing a device that secures all samples together during drawing and during transport, specimen integrity is improved. Labeling the device itself further improves specimen integrity.

While considerable emphasis has been placed herein on the structures and configuration of the disclosed embodiments, it will be appreciated that other embodiments, as well as modifications of the embodiments disclosed herein, can be made without departing from the principles of the disclosure. In this respect, it will be appreciated that the tube holder can be used in various kinds of applications. Likewise, it will be appreciated that a tube holder according to the disclosure can be of any number of different dimensions. These and other modifications of the embodiments shown will be obvious and suggested to those skilled in the art from the disclosure herein. It is to be distinctly understood that the foregoing descriptive matter is to be interpreted merely as illustrative and not as a limitation thereof. Obviously, modifications and alterations will occur to others upon a reading and understanding of this specification. It is intended that the disclosure be construed as including all such modifications and alterations as fall within the scope of the appended claims or the equivalents thereof.

Having thus described the invention, it is claimed:

1. An apparatus for holding and transporting fluid collection tubes, comprising:
a tube holder having an elongated body with a plurality of expandable sleeves having a circumferential dimension and a length for receiving and retaining a plurality of fluid collection tubes;
said sleeves having open first ends and open second ends;
said sleeves are spaced from and generally parallel to one another;
said fluid collection tubes including a first end, an enlarged second end, and a cylindrical body therebetween;
said circumferential dimension of said sleeves sized to permit said first end from passing therethrough while preventing said second end from passing therethrough, whereby said fluid collection tubes are pushed from said second end in a first direction for mounting to said tube holder and pushed from said first end in a second direction for dismounting from said tube holder;
said tube holder including another expandable sleeve having another circumferential dimension for receiving a sample retriever tube; and,
each said sleeve including an inner surface having at least three contact ribs extending inwardly for releasably frictionally gripping said fluid collection tubes and said sample retriever tube.

2. The apparatus of claim 1, wherein said plurality of sleeves for said fluid collection tubes expandable from a first circumferential dimension to a second circumferential dimension.

3. The apparatus of claim 1, wherein said first and second directions are co-linear and opposite.

4. The apparatus of claim 3, wherein said at least two ribs are parallel and opposed to one another and extend along said length of said sleeve.

5. The apparatus of claim 4, wherein said fluid collection tube body includes a length extending from said first end to said second end; and,
said sleeve length is less than one half said tube body length whereby a coefficient of friction provides a retention force to said tubes for retention in said sleeves.

6. The apparatus of claim 4, wherein said fluid collection tube body includes a length extending from said first end to said second end; and,
said sleeve length is less than one third said tube body length whereby a coefficient of friction provides a retention force to said tubes for retention in said sleeves.

7. The apparatus of claim 4, wherein said fluid collection tube body includes a length extending from said first end to said second end; and,
said sleeve length is between 15% and 30% of said tube body length whereby a coefficient of friction provides a retention force to said tubes for retention in said sleeves.

8. The apparatus of claim 1, wherein said tube holder body includes a hole therethrough proximal to an end for hanging said tube holder.

9. The apparatus of claim 1, wherein said tube holder body includes an identification area for documenting information.

10. The apparatus of claim 1, wherein said sleeves define a circumferential contact area between said inner surface of said sleeve and an outer circumference of said tube body, said circumferential contact area between said inner surface and said tube body is discontinuous when said tube is mounted in said sleeve.

11. The apparatus of claim 10, wherein said circumferential contact area is between 45% and 85%.

12. The apparatus of claim 10, wherein said circumferential contact area is between 55% and 75%.

13. A fluid collection tube holder and transporter for use in holding and transporting fluid collection tubes, comprising:
a tube holder having an elongated body with a plurality of sleeves thereon for receiving and retaining a plurality of fluid collection tubes;
said plurality of fluid collection tubes including a first end, an enlarged second end, and a cylindrical body therebetween;
each of said plurality of sleeves including an inner surface having a plurality of contact edges extending inwardly for frictionally engaging an exterior side of said cylindrical body of one of said plurality of fluid collection tubes;
said sleeves define a circumferential contact area between said inner surface of said sleeve and said exterior side of cylindrical body, said circumferential contact area between said inner surface and said cylindrical body is discontinuous when said tube is mounted in said sleeve; and,
said plurality of edges defining an expandable inner circle circumscribing said plurality of contact edges wherein said inner circle expandable from a first diameter to a second diameter.

14. The apparatus of claim 13, wherein said circumferential contact area is between 45% and 85%.

15. The apparatus of claim 13, wherein said plurality of sleeves including at least four said sleeves.

16. The apparatus of claim 13, wherein said plurality of sleeves include a cross section comprising a star pattern.

17. The apparatus of claim 13, further including at least another sleeve thereon for receiving and retaining a sample retriever tube.

18. The apparatus of claim 16, wherein said star pattern includes at least five contact edges.

19. The apparatus of claim 16, wherein said star pattern includes at least six contact edges.

20. The apparatus of claim 13, wherein each of said plurality of sleeves including an outer surface having a plurality of edges defining an outer circle circumscribing said outer edges and including a third diameter;
said third diameter greater than said second diameter.

21. The apparatus of claim 13, wherein said second diameter of said sleeves sized to permit said first end from passing therethrough while preventing said second from passing therethrough, whereby said fluid collection tubes are pushed from said second end in a first direction for mounting to said tube holder and pushed from said first end in a second direction for dismounting from said tube holder.

22. The apparatus of claim 13, wherein said fluid collection tube body includes a length extending from said first end to said second end; and,
said sleeve includes a length, said sleeve length is less than one third said tube body length whereby a coefficient of friction provides a retention force to said tubes for retention in said sleeves.

23. A blood collection tube holder and transporter for use in holding and transporting fluid collection tubes, comprising:
a tube holder having an elongated body with a plurality of sleeves thereon for receiving and retaining a plurality of fluid collection tubes;
said plurality of fluid collection tubes including a first end, an enlarged second end, and a cylindrical body therebetween;
each of said plurality of sleeves including an inner surface having a plurality of contact edges extending inwardly for frictionally engaging an exterior side of said cylindrical body of one of said plurality of fluid collection tubes;
said sleeves define a circumferential contact area between said inner surface of said sleeve and said exterior side of cylindrical body, said circumferential contact area between said inner surface and said cylindrical body is discontinuous when said tube is mounted in said sleeve; and,
said circumferential contact area is between 45% and 85%.

24. The apparatus of claim 23, wherein said plurality of edges defining an expandable inner circle circumscribing said plurality of contact edges wherein said inner circle expandable from a first diameter to a second diameter.

25. The apparatus of claim 23, wherein said plurality of sleeves including at least four said sleeves.

26. The apparatus of claim 23, wherein said plurality of sleeves include a cross section comprising a star pattern.

27. The apparatus of claim 23, wherein said fluid collection tube body includes a length extending from said first end to said second end; and,
said sleeve includes a length, said sleeve length is less than one third said tube body length whereby a coefficient of friction provides a retention force to said tubes for retention in said sleeves.

28. A method of collecting fluid samples from a donor comprising the steps of:
mounting a tube holder to a drawer's hand, said tube holder includes a flexible body having at least one sleeve thereon for receiving and securing at least one fluid collection tube, said tube holder is moveable about the hand;
removing said at least one fluid collection tube from said holder and engaging a depositing needle, said needle is in communication with a fluid sample;
filling said at least one fluid collection tube with the fluid sample; and,
moving said at least one fluid collection tube away from said depositing needle and replacing said at least one fluid collection tube in said holder.

29. The method of claim 28, further comprising the steps of:
removing at least a second fluid collection tube from said holder and engaging a depositing needle;
filling said at least second fluid collection tube with the fluid sample; and,
moving said at least second fluid collection tube away from said depositing needle and replacing said at least second fluid collection tube in said holder.

30. The method of claim 29, further comprising the steps of:
dismounting said tube holder from the drawer's hand; and,
documenting donor information onto an identification area.
